(19) United States
(12) Patent Application Publication
(10) Pub. No.: US 2014/0039864 A1
(43) Pub. Date: Feb. 6, 2014

(54) METHOD, COMPUTER PROGRAM PRODUCT, AND APPARATUS FOR SIMULATING ELECTROMAGNETIC IMMUNITY OF AN ELECTRONIC DEVICE

(71) Applicants: Bertrand Vrignon, Plaisance du Touch (FR); Mikael Deobarro, Toulouse (FR); John Shepherd, Blagnac (FR)

(72) Inventors: Bertrand Vrignon, Plaisance du Touch (FR); Mikael Deobarro, Toulouse (FR); John Shepherd, Blagnac (FR)

(73) Assignee: Freescale Semiconductor, Inc., Austin, TX (US)

(21) Appl. No.: 14/111,572

(22) PCT Filed: Apr. 21, 2011
(86) PCT No.: PCT/IB2011/001218

§ 371 Date: Oct. 14, 2013

(51) Int. Cl. G06F 17/50

(52) U.S. Cl. CPC G06F 17/5009
USPC 703/13

(57) ABSTRACT

There is disclosed a method of simulating Electromagnetic (EM) immunity of an electronic device, comprising applying a disturbing signal on at least one first entry point of a model of the device and monitoring a disturbed signal on at least one observation point of said model of the device; and, automatically varying the frequency and the level of the disturbing signal stepwise until a default is just detected in the disturbed signal, wherein at each frequency and level step, a simulation is run up to a dwell time and resulting simulation data is examined for a default condition.

### FIELD OF THE INVENTION

This invention relates to a method of simulating electromagnetic (EM) immunity of an electronic device, a computer program product having comprising one or more stored sequences of instructions to perform steps of the method, and programmable apparatus configured to carry out the method.

### BACKGROUND OF THE INVENTION

Electromagnetic compatibility (EMC) is a fundamental constraint that all electric or electronic equipments must meet to ensure the simultaneous operation of electric or electronic devices present at the same time in a given area, for a given electromagnetic environment.

By definition, EMC covers two complementary aspects: the electromagnetic emission and the immunity to electromagnetic interferences. When designing new electric or electronic devices, it is desirable both to keep the emission low and to ensure robustness of the device, such that it complies with certain limits. Mainly, such EMC limits are defined by standards, e.g. CISPR 25, “Radio disturbance characteristics for the protection of receivers used on board vehicles, boats, and on devices—Limits and methods of measurement”, IEC, 2002.

Immunity to electromagnetic noise has played a significant role in the design of integrated circuits for many years and remains a major concern with the multiplication of powerful parasitic sources which can affect circuit behaviour, such as mobile phones, high speed networks and wireless systems.

Either by common-mode impedance, radiated coupling, mutual coupling or capacitive coupling, the disturbances can couple and propagate toward the possible entry points of the integrated circuit: inputs, outputs, peripheral and core supply or via the common substrate.

Disturbances can cause temporary malfunctions (as binary errors, voltage drifts, jitter, unwanted resets . . . ) or even permanent damage to the electronic equipment (oxide breakdown, latch-up . . . ). In automotive applications, most of the internal disturbances are generated during the normal operation of the vehicle by sources like the ignition system, the generator and alternator system, the switching of electric motors or actuators.

Simulation of EM emissions and immunity during the design phase of integrated circuits allows potential weaknesses to be detected before the product is first manufactured. Hence, when weaknesses are detected by measurements on the manufactured device, the cost of redesign and manufacture may be prohibitive and external solutions to reduce emissions and/or EM sensitivity may be preferred, even if the customer is usually unwilling to bear the cost and drawbacks of additional protection components to his application.

Simulating the EM immunity has become a major issue in the electronic industry. Existing CAD (Computer Aided Design) tools do not automate the procedure. Up to now, there is no CAD tool automating the flow for immunity simulation in the time domain. In a typical simulation flow, the simulation of the operation of the DUT (Device Under Test) with a disturbing signal at a given frequency and at a given power is first completed, and only then can the data be checked for a failure. The post processing to determine the immunity level has to be done manually. Thus, it takes a very long time to efficiently simulate the operation of the circuit over relevant frequency and power ranges. Attempts to reduce the simulation time on this basis may result in a procedure which is not accurate and can lead to a false immunity level. The following publications describe methods to simulate the immunity, but do not propose methods of reducing simulation time:

A. Boyer, “Modeling of a Direct Power Injection Aggression on a 16 bit Microcontroller Input Buffer”, EMCcompo07, Torino, Italy, 2007; and,

E. Sicard, A. Boyer, “IC-EMC, User's Manual, part 7: Immunity simulation”, pages 162-183, version 2.0, published by INSA Toulouse, ISBN 978-2-87649-056-7, July 2009.

In particular, IC-EMC simulation software exploits simulation results provided by WinSPICE to allow extracting relevant EMC information thanks to a set of post-processing tools. To that end, there is applied to a device a disturbing signal whose amplitude is modulated by a ramp. The amplitude of the disturbing signal is therefore continuously changing and there is no well defined dwell-time. Furthermore, the simulation continues until the end of the ramp is reached.

### SUMMARY OF THE INVENTION

The present invention provides a method, a computer program product, and an apparatus for simulating electromagnetic immunity of an electronic device as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 schematically shows an example of an embodiment of a simulation apparatus adapted for carrying out embodiments of the simulation method.

FIG. 2 is a flowchart illustrating steps of a known method of measuring EM immunity on actual devices under test.

FIG. 3 is a flowchart illustrating the principle of the proposed method of automatically simulating EM immunity of electric or electronic devices or systems.

FIG. 4 illustrates embodiments of the method of FIG. 3.

FIGS. 5 and 5a are flowcharts showing steps of another embodiment of the method, and FIGS. 5b and 5c show test limits around a non disturbed signal at an observation point, used to assess whether there is a default.

FIGS. 6 to 9 are flowcharts of further embodiments of the proposed method.

### DETAILED DESCRIPTION OF THE PREFERRED EMBODIMENTS

Because the illustrated embodiments of the present invention may for the most part, be implemented using electronic components and circuits known to those skilled in the art, details will not be explained in any greater extent than that considered necessary, for the understanding and appreciation of the underlying concepts of the present invention and in order not to obfuscate or distract from the teachings of the present invention.

Embodiments of the invention allow reducing the time required for EM immunity simulations. Although in this document emphasis is placed on the immunity of integrated circuits, the invention can also be applied to simulations of EM immunity of systems, modules and finished products such as motor vehicles, mobile phones, etc., and any part of them. Therefore, though the present description of embodiments is based on the example of the simulation of an electronic circuit, its teachings encompasses any type of electronic device, which include systems or sub-systems for which simulation of EM immunity is desirable.

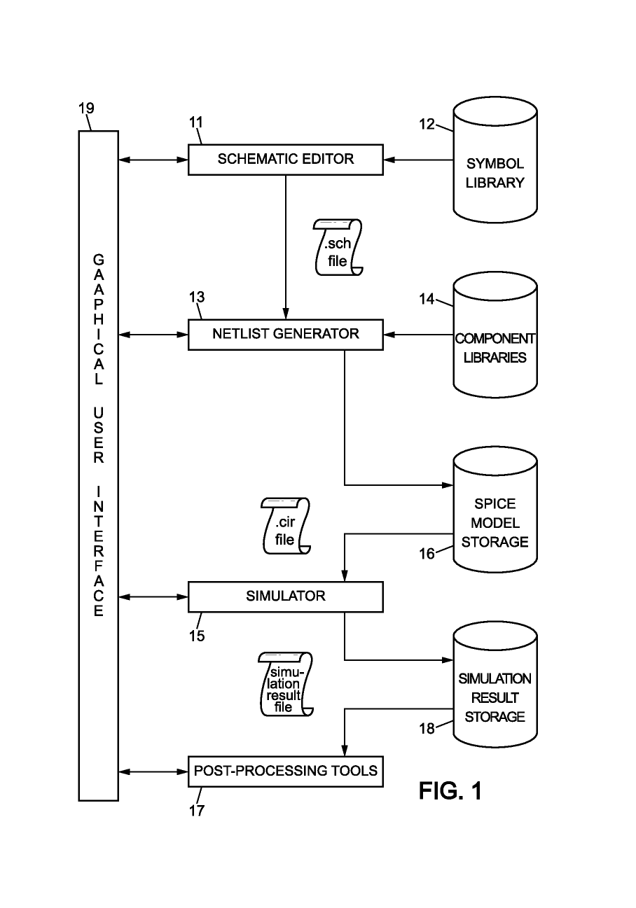

FIG. 1 describes the general architecture of a simulation apparatus 10 embodying the invention. The simulation device may be based on the SPICE™ (Simulation Program with Integrated Circuit Emphasis) suite of software tools, and may be implemented as a programmable apparatus, such as a computer system.

The simulation apparatus 10 comprises a schematic editor module 11 which is in charge of the edition of the IC schematic, and which may generate a file of the “.sch” type. The schematic editor may comprise, or is otherwise associated with, a symbol library 12 storing symbols of components used in the circuit design of the IC. Thus, the symbol library may be internal or external to the simulation device 10. This database, in one embodiment, uses an object-oriented approach to represent each component in the architecture of an IC, including: Central Processing Unit (CPU), on-chip network buses, functional blocks also referred to as IP (Intellectual property), power supply and ground planes, electrical interconnect (i.e., wiring), and other similar components. Unified schema objects of the database link the components together based on their logical and physical relationships.

Component models, adapted to describe the electrical characteristics and operation of all components of the IC, are provided by component libraries 14 of the device. Some or all of these libraries may be external to the device.

The apparatus further comprises a netlist generator module 13, which generates a SPICE™ model of the circuit adapted to serve as input file for a simulator module 15. This netlist file may be of the “.cir” type, that is to say a netlist format compatible with the analog simulation tool WinSPICE™. It contains the netlist description of the circuit. It may be stored in a SPICE™ model storage unit 16, to become available to the simulator module 15.

The simulator module 15 may be a software processing unit configured to execute circuit simulation based on the model of the circuit. It may be WinSPICE™, for instance. Alternative simulators, based on other component models may also be provided.

At the end of a simulation run, simulation results are made available in the form of a simulation result file, which may be accessed by post-processing tools 17. Different simulation result file formats may be supported by the device. More than one simulation result file may be stored in a simulation result storage unit 18 which, again, may be internal or external to the computer system.

Finally, the simulation apparatus comprises a Graphical User Interface (GUI) 19, which provides Input/Output functionality using editing and controlling icons and menus, viewing screens, plot printers, etc. In particular, the status of each simulation run may be displayed to the user through this interface.

Embodiments of the invention propose a new EM immunity simulation scheme which, instead of being executed at the post-processing level, is operated at the simulator level in order to save simulation execution time. In order to achieve this, the simulator advantageously includes functions allowing default conditions to be detected “on-the-fly”, and allowing the simulation to be stopped or paused and restarted with new conditions.

Thus, the proposed simulation scheme is similar to methods used to reduce the time of actual EM immunity measurements. More precisely, embodiments may reproduce by simulation features of the immunity measurement flow chart defined, e.g., in the standard IEC 62132.

To that end, the applied RF power of a disturbing signal at a given frequency is increased stepwise until a failure is detected or until a specified maximum power is reached. When a failure occurs, the simulation at the current frequency is stopped and the process jumps to the next frequency. Refinements are added to further reduce simulation time by basing the initial conditions at the next frequency on the conditions in which the failure was detected at the previous frequency.

Detailed description of embodiments of the proposed EM immunity simulation process will be provided below, but let us first describe today's existing standards for the measurement of EM immunity of actual manufactured products.

For example, in the case of integrated circuits, standard IEC 62132 is applied to measurements using continuous wave (CW) and amplitude modulated (AM) sine wave disturbing signals, and standard IEC 62215 is applied to measurements using impulse disturbances.

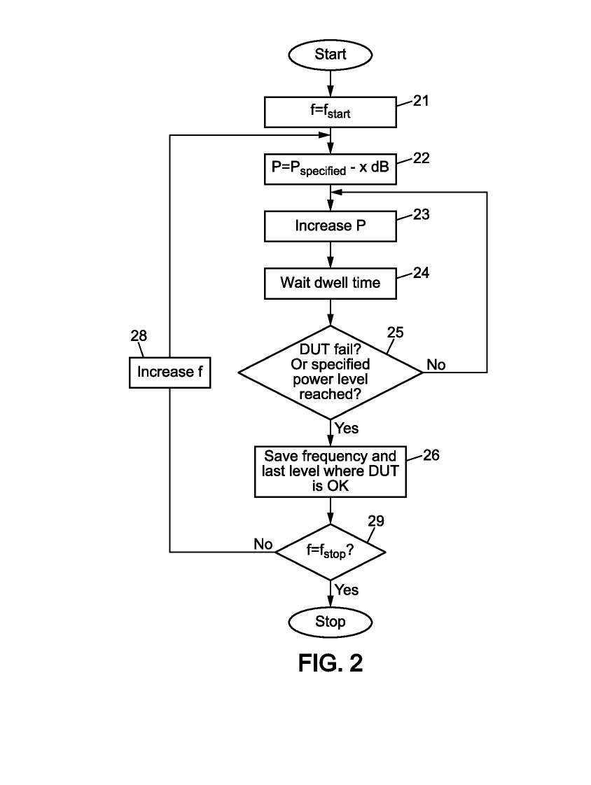

FIG. 2 presents the flowchart of immunity measurements as described in IEC 62132-4, which is a Direct Power Injection (DPI) test, i.e., measurement procedure.

At step 21 and step 22, an initial frequency and an initial power, respectively, of a disturbing signal are defined. At step 24 this disturbing signal is applied to the device under test (DUT) during a dwell time and its amplitude is increased stepwise at step 23, until a default is detected at step 25.

A default may be a change in an output signal (e.g. amplitude, DC level, phase shift, jitter, frequency, etc), a change of state (e.g. a digital signal passing from a low to a high state, or vice-versa) or any other indication of a malfunction of the device. The default may be detected by the simple measurement of a signal level (amplitude or DC), a frequency, etc. In cases where the default is a difference between the nominal output signal (i.e. the signal when no disturbing signal is applied) and the disturbed signal, limits are placed around the nominal signal.

As soon as a default is detected, the level of the disturbing signal is noted (step 26) and the measurement is carried out again by changing a parameter such as frequency of a sine wave or shape of the impulse, at step 28, unless it is determined at step 29 that the maximum frequency has been reached. The process returns to step 22 where the signal level is reset to a suitable minimum level. In the case of measurements on a real device a maximum disturbing signal level is specified and the measurement is stopped, also at step 25, when this level is reached. Indeed, it is easily understood that the level of the disturbing signal cannot be increased beyond such maximum power without a risk of damage to the device.

EM immunity measurements following the above flowchart are generally automated by controlling the measurement equipment remotely with a controller, such as a personal computer. In order to be certain that a default condition will be detected, the dwell-time is specified as the time during which the controller needs to permanently check for a default at a given disturbing signal level. The dwell-time may last from a fraction of a second to several seconds. This leads to excessively long measurement times.

The measurements are stopped as soon as a default is detected, rather than continuing to the end of the dwell-time. This allows reducing the measurement time. Also, the level of the disturbing signal for the next frequency is not reduced to the minimum level, but to a level only slightly below the level at which the default was previously detected (noted x dB, at step 22 in FIG. 1). This avoids having to measure at levels where there is little chance of finding a default, thereby further reducing the measurement time.

In the case of the simulation of EM immunity according to known methods, on the contrary, it is usual practice to run a complete simulation before looking for a default condition in the resulting data by using post-processing tools. The simulation is therefore very time consuming. The resulting amount of data is enormous and the post processing is also very long. This is worsened when the frequency of the disturbing signal is many times that of the disturbed signal, or vice versa. In a transient (time domain) simulation the number of points to be simulated depends on the resolution required (i.e. number of points for one cycle of the highest frequency to be simulated). For example, with a disturbing signal at 1 Gigahertz (GHz) and an observed signal at 1 Megahertz (MHz), 1000 cycles of disturbing signal must be simulated for one period of observed signal. Moreover, if a resolution of 10 points per cycle of disturbing signal is required and ten cycles of observed signal are needed to ensure good detection of a default (i.e, for a dwell-time corresponding to ten cycles), the number of points reaches 100 000. This simulation must be run for each power level and for each frequency of the disturbing signal which need to be considered. In many modern simulators (for example, the MICA simulator developed by Freescale), the time step is automatically reduced as the slope of a signal increases. This avoids calculation when the signal is changing slowly. But in the case of a sine wave, this is not particularly advantageous.

In order to save simulation time, there is proposed, according to embodiments of the invention, a method of simulating electromagnetic (EM) immunity of an electronic device, comprising steps of applying a disturbing signal on at least one first entry point of a model of the device and of monitoring a disturbed signal on at least one observation point of said model of the device. The method further comprises automatically varying the frequency and the level of the disturbing signal stepwise until a default is just detected in the disturbed signal. At each frequency and level step, a simulation is run up to a dwell time at the most, and resulting simulation data is examined for a default condition on the fly.

The immunity levels are simulated in the similar way to the immunity measurement methods. To go faster, all steps are automated and when a default is detected, the immunity simulation is stopped immediately and then goes to the next frequency. This simulation method can be applied for all types of immunity tests: radiated, conducted and impulse.

In some embodiments, simulations may be run at each frequency for respective levels of the disturbing signal, either increasing up to a given maximum level or decreasing down to a given minimum level, and, when a default is just detected, said simulations at said frequency are stopped and the corresponding level is stored, and new simulations are started at a next frequency with a level reduced or increased, respectively, by a first given quantity from the stored level.

For instance, the simulations at a given frequency are stopped when the level reaches the maximum level or minimum level, respectively, without a default being detected, and new simulations are started at the next frequency with a level reduced by a second given quantity from the maximum specified level or increased by said second defined quantity from the minimum specified level, respectively.

Thus, this solution automates all simulation steps during the immunity simulation. For example, a default (i.e., when the monitored signal is outside a limit test mask) occurring at a given frequency and power level of the disturbing signal will be automatically detected and stored, and the simulation will be automatically continued at the next frequency. Therefore, embodiments of the invention reduce the simulation time and provide more accurate simulation results than known methods.

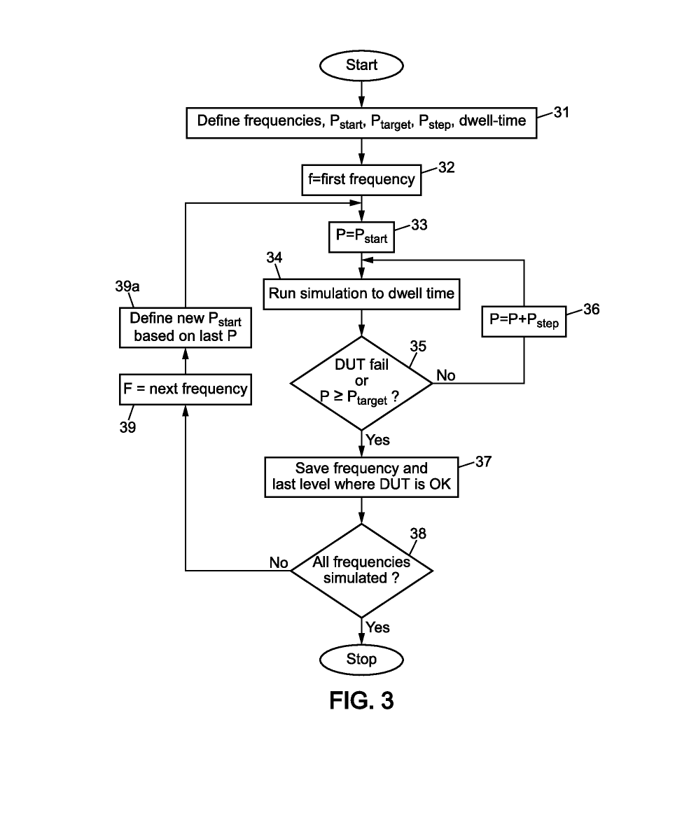

FIG. 3 shows a flowchart of embodiments of the proposed simulation method as defined above. This figure aims at presenting the flow to simulate the immunity of a circuit to radiofrequency interference (RFI).

In this simplified example, a sinusoidal conducted disturbing signal is injected, e.g. on the power supply pin of a digital circuit, until the noise level measured, e.g. on one pin of an output buffer, exceeds the noise margin. The circuit under test, we should say under simulation, may be a microcontroller. There is used a schematic of the microcontroller and its operating environment, which further models the conducted injection of RFI in the power supply of the microcontroller according to the IEC 62132-3 DPI standard. The immunity of the circuit is evaluated in term of noise sensed on the above mentioned pin of the output buffer of the microcontroller.

The injection device used to produce the RF disturbance may consist in a sinusoidal source with a 50 ohms output resistor. An element composed of an injection capacitor and a choke inductance required to superimpose a RF disturbance to a low frequency signal (e.g. the power supply voltage), may be further added to the circuit model. Frequency and power of the RF disturbance varies during simulation, and are automatically controlled based on user defined start, stop and increment parameters. The output buffer is sensed by an active probe modelled by a parallel RC cell, also added to the model.

The simulated immunity criterion is the voltage across this probe. In one example, the output buffer is tied to a 5 V voltage. The immunity criterion in this test is reached, namely it is determined that there is a failure, when the amplitude of noise sensed at the observed pin of the output buffer of the microcontroller exceeds 1 V (20% of the supply voltage).

In a first step 31 of the process there is configured, in respective fields of the GUI, a start power level Pₛₜₐᵣₜ, a target power level P_{target}, a power sweep or power step Pₛₜₑₚ, as well as a dwell time. The power step Pₛₜₑₚ corresponds to the above mentioned first quantity, by which the power is increased or decreased stepwise.

In one embodiment where the power of the disturbing signal is increased stepwise, the minimum power Pₛₜₐᵣₜ may be set to e.g. 15 dBm while the maximum power P_{target} is set to e.g. 45 dBm. In this example, the maximum injected power for the frequencies where a failure is not reached during simulation, is thus limited to 45 dBm.

The power step Pₛₜₑₚ may be equal to 1 dB. The smaller the power step, the better is the accuracy of the simulation results.

The frequency sweep may be configured to, e.g., 10 points between 10 MHz and 100 MHz.

Finally, the configurable duration of each simulation step (i.e, for each couple of frequency step and each frequency step), called the dwell time, may be set to, e.g., 10 μs for every frequency. The longer the dwell time, the better is the accuracy of the simulation result.

In a variant, at least one of the start power Pₛₜₐᵣₜ, the target power P_{target}, power step Pₛₜₑₚ, the frequency sweep and the dwell time is not configurable via a corresponding field of the GUI, but is fixed to a given value.

In steps 32 and 33, the frequency f of the disturbing signal is set to the first frequency (i.e., 10 MHz) and its power P is set the minimum power Pₛₜₐᵣₜ (i.e., 15 dBm), respectively.

In step 34, a transient simulation of the circuit is launched and run until the specified dwell time.

In step 35, it is determined whether there has been a failure in the device, that is to say whether a default has been detected, according to the immunity criterion as defined. In one example, a default is determined to be detected if the sensed voltage at the observed pin of the output buffer of the microcontroller is 5 V−1 V=4 V, or less. In a variant or in supplement, a default may also be considered to be detected if the sensed voltage at the observed pin of the output buffer of the microcontroller is 5 V+1 V=6 V, or more.

If the answer to this determination test is no, then the power P of the disturbing signal is increased by Pₛₜₑₚ at step 36, unless P already reached P_{target}. If, on the contrary, a failure is detected at step 35, then, at step 37, the simulation run is stopped before end, and the frequency f is saved in a simulation results file, along with the last value P of the power of the disturbing signal where the device had been determined to be safe. At step 36, the increase in level can be adapted to the nearness of the disturbed signal to the limits (based on simulation results at previous frequency).

In a step 38, it is then determined whether all the frequencies to be tested within the set frequency range have been simulated. If yes, then the simulation of the device reaches the end, otherwise, in step 39, the frequency of the disturbing signal is changed to the next frequency to be simulated. Advantageously, at step 39a, the start power Pₛₜₐᵣₜ is given a new value in consideration of the last value the power P at which a default was detected, such being the case. More precisely, the increase in power level can be adapted to the nearness of the disturbed signal to the limits. This allows avoiding running simulation steps for values of P where a default is not likely to be detected, in view of the simulation result at the former frequency. The process then loops to step 33 so that another simulation run is launched for another dwell time.

Further refinements to optimize and reduce automatically the simulation time as a function of the previous simulations may be added to the method, as will be explicated in what follows.

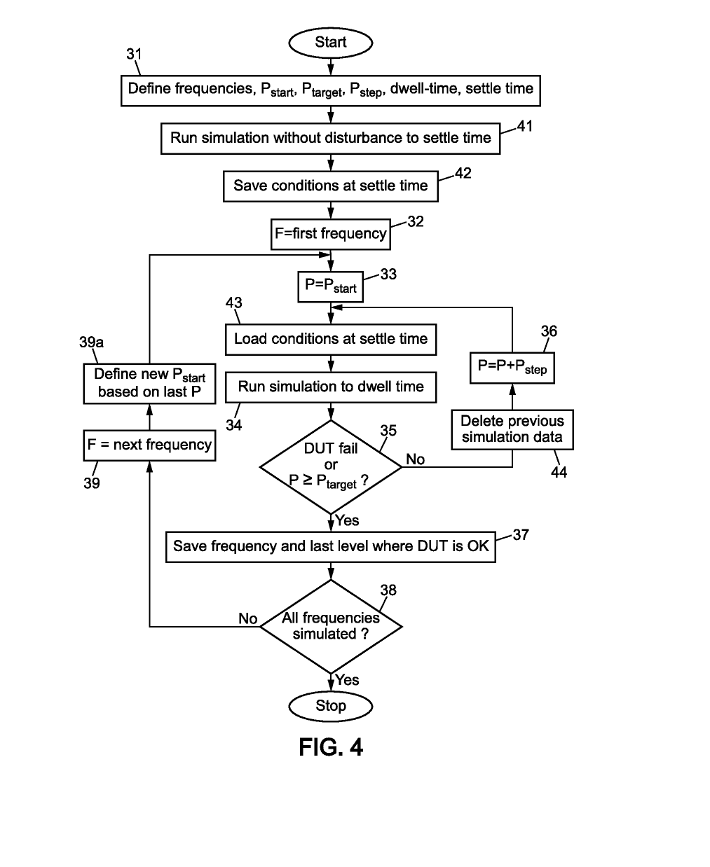

For example, in one embodiment illustrated by the flow chart of FIG. 4, wherein the same steps as in FIG. 3 bear the same reference numerals, there may provided a step 41 followed by a step 42, between steps 31 and 32, which correspond to an initial simulation which is run in order to save the signal waveform in nominal conditions. Thus, in step 41, a first simulation is run before applying the disturbing signal to the model of the circuit. Namely this first simulation step is run with no disturbing signal, until a given time, referred to as a settle time, at which it is considered that a steady state of the device under test has been reached. In step 42, data of the undisturbed signal at the observation point of the device over the dwell time are saved for use during the following simulations which have been already described above in view of FIG. 3.

Also illustrated by FIG. 4, another refinement provides that, in a step 44 between steps 35 and 36, in cases where there is not a default, the waveform data corresponding to the previous simulation is deleted. This embodiment allows avoiding storing all the simulation results. For instance, the process keeps only the last simulation results where the signal goes outside the limits and deletes all the other simulations for a given frequency. If there is not a default, the waveform is deleted thus avoiding storing all the simulation results. This way, the process keeps only the last simulation results where the signal goes outside the limits and deletes all the other simulations for a given frequency.

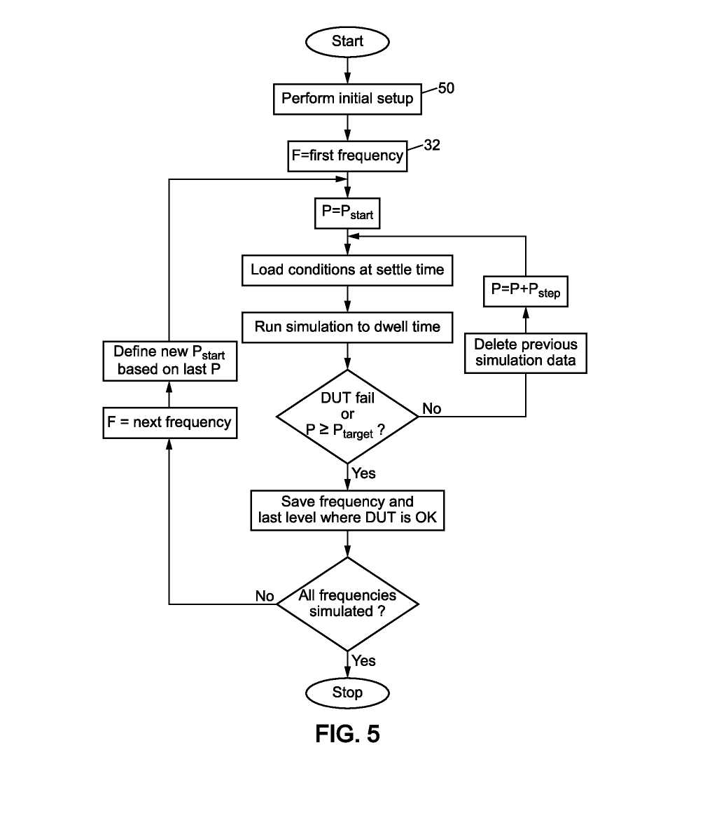

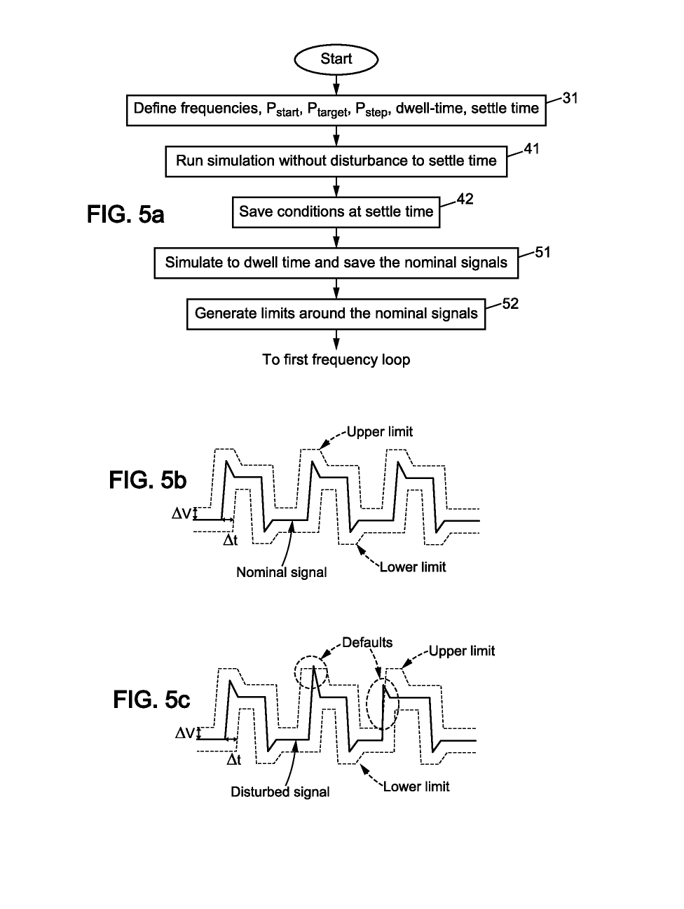

In one particular embodiment illustrated by FIGS. 5, 5a, 5b and 5c, data of the undisturbed signal at the observation point of the device are used to generate limits around the undisturbed signal. These limits correspond, for instance, to given deviations in level and/or time from the undisturbed signal and being stored to be used for the following simulations. Other limits may also be provided, depending on the type of simulation concerned.

This embodiment of the method is illustrated by the flow chart of FIG. 5, which corresponds to FIG. 4 except that all steps before step 32 are grouped in an initial setup 50, which is detailed by the flow chart of FIG. 5a.

More specifically, nominal, namely undisturbed, signals may be obtained and saved at step 51 which comes after step 42, by running simulations without any disturbing signal up to the dwell time defined in step 31. Limits around the nominal signals thus obtained, may be generated at step 52, which completes the initial setup 50.

In one example shown in FIG. 5b, the amplitude of the observed signal may not vary by more than ΔV and its timing by more than Δt, these limits being shown in dotted lines. For instance, an algorithm may calculate automatically the test limits according to the specified tolerances (e.g., ΔV and Δt).

Then, the process is continued by running simulations stepwise with disturbing signals of given frequency and power. At each of these simulation runs, the test conditions obtained from the undisturbed signal at the settle time are loaded and the simulations are re-run with the disturbing signal up to the dwell time. At step 35, an algorithm compares the disturbed signal with the test limits. Stated otherwise, for each level at the end of a simulation run, the disturbed signal is compared to the test limits. If a default is detected or if the level reaches the target level, the simulator goes to the next frequency (step 36). Otherwise, the level is increased (step 39).

FIG. 5c illustrates the detection of defaults when the disturbed signal goes outside the limits.

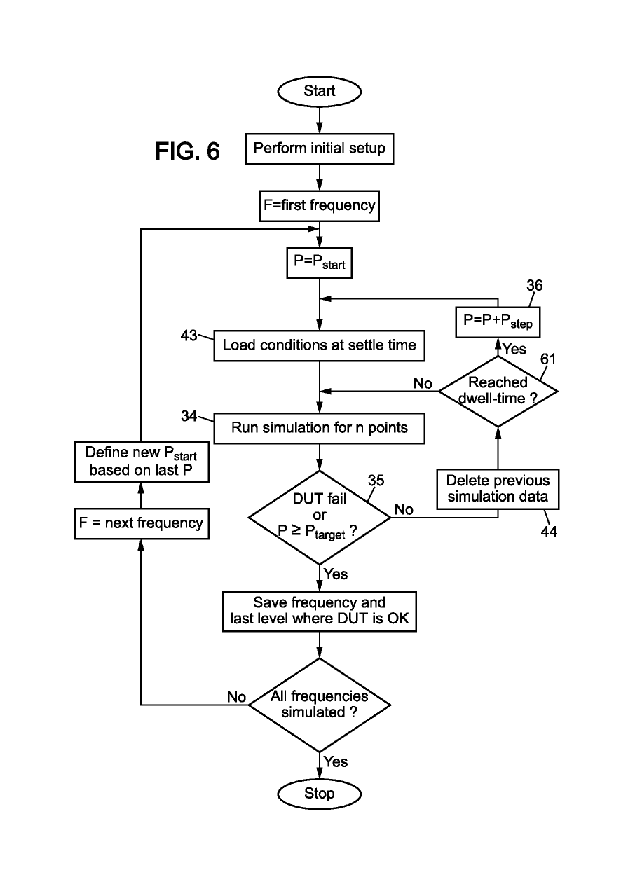

Turning now to the flow chart of FIG. 6, there will be described a further embodiment wherein, at each frequency and level step, the simulation is not run continuously over the dwell time. Instead, the simulation is performed for n given instants over said dwell time, where n is an integral number. For each of these n iterations of modified simulation step 34, the resulting data of the disturbed signal at corresponding simulation instants over the dwell time is compared at step 35 with the limits around the nominal signal at said instants. If the resulting data for these points exceeds one of the limits, the ongoing simulation run is stopped and a new simulation run is started at the next frequency (the method then proceeding with steps 37, 38, 39, etc. as already described above).

In FIG. 6, this is illustrated by an additional loop including a test at step 61, which comprises determining whether the n^{th} instant over the dwell time has been reached or not. If not, then the process loops to step 34 of running a simulation and then to step 35 of determining whether there is a default. If yes, on the contrary, then the process continues with step 36.

In this embodiment, determination step 35 is carried out n times for each simulation step instead of only once, but the amount of data to be processed in total may be less than when this embodiment is not implemented. A default condition is considered to be met if, for at least one instant, the data of the disturbed signal exceeds the limits around the nominal signal at the corresponding instant. In a transient simulation, the intervals of time between simulation instants may correspond to a time step of, e.g., 1 ns.

This embodiment allows stopping the simulation at the given frequency as soon as a default is detected, instead of performing the simulation up to the dwell time. Thus, the simulation time is further reduced.

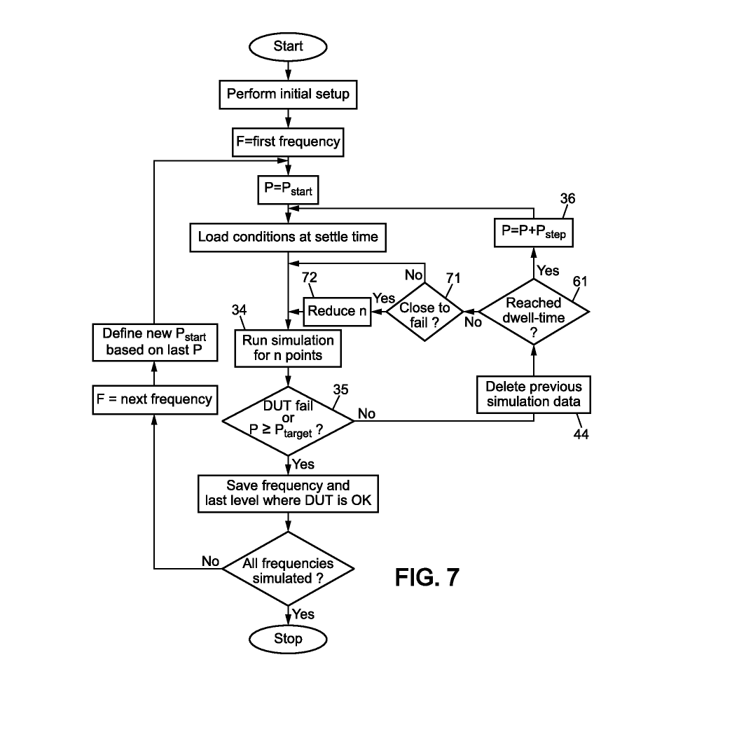

The flowchart of FIG. 7 presents a still enhanced embodiment of the method according to FIG. 6 in which the simulation is run only for n points and not all the dwell time. According to the embodiment of FIG. 6, the disturbed signal may be compared with the limits after that n points have been simulated instead of waiting until the dwell time has been reached. With embodiment of FIG. 7, the value of n can be refined at each loop in order to further reduce the simulation runtime.

Indeed, an algorithm can change automatically the value of n depending, e.g., on the margin between the disturbed signal and the test limits. This may be implemented by an additional test at step 71, provided between step 61 of FIG. 6 and step 34.

When, for instance, the disturbed signal is in the middle of the mask shape of FIG. 5b, that is to say when we are not close to the detection of a default, then the value of n can be increased or left unchanged. In the example as shown in FIG. 7, n is unchanged and the process goes directly to step 34.

On the contrary, if the disturbed signal is nearing the test limits, meaning that we are close to a default to be detected, then n can be reduced at step 72 which, in the flowchart of FIG. 7, is carried out between step 71 and step 34.

This embodiment allows increasing the accuracy of the simulation results.

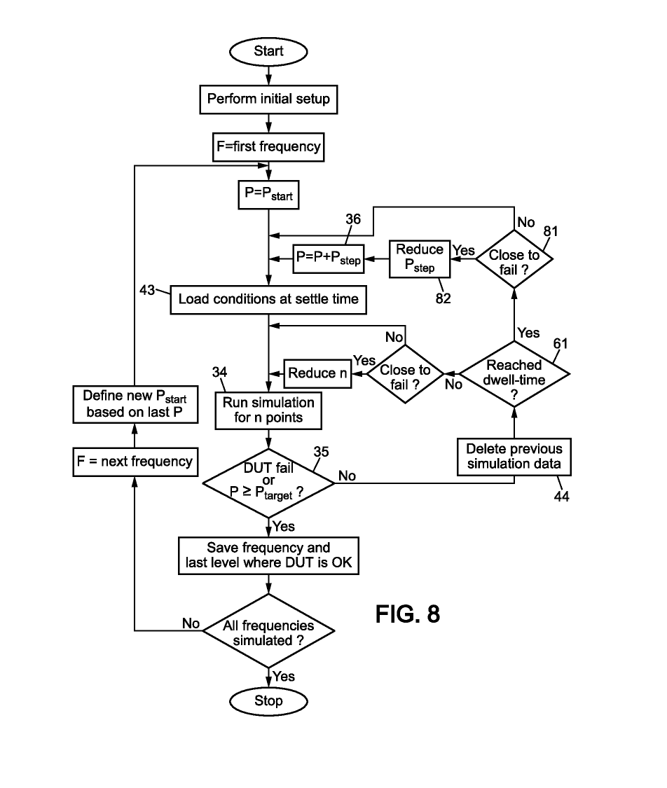

In yet another embodiment presented in FIG. 8, the quantity of change of power level Pₛₜₑₚ from one simulation to the other may be adjusted depending on the nearness of the disturbed signal to the limits, so as to further increase the accuracy of the results.

This result may be achieved by adding another test at step 81, between step 61 of FIG. 6 and step 43 of FIG. 4. When we are not close to the detection of a default, then Pₛₜₑₚ can be reduced at step 82 before proceeding with step 36 of increasing P by Pₛₜₑₚ.

On the contrary, if the disturbed signal is not nearing the test limits, meaning that we are not close to a default to be detected, then the process jumps directly to step 43.

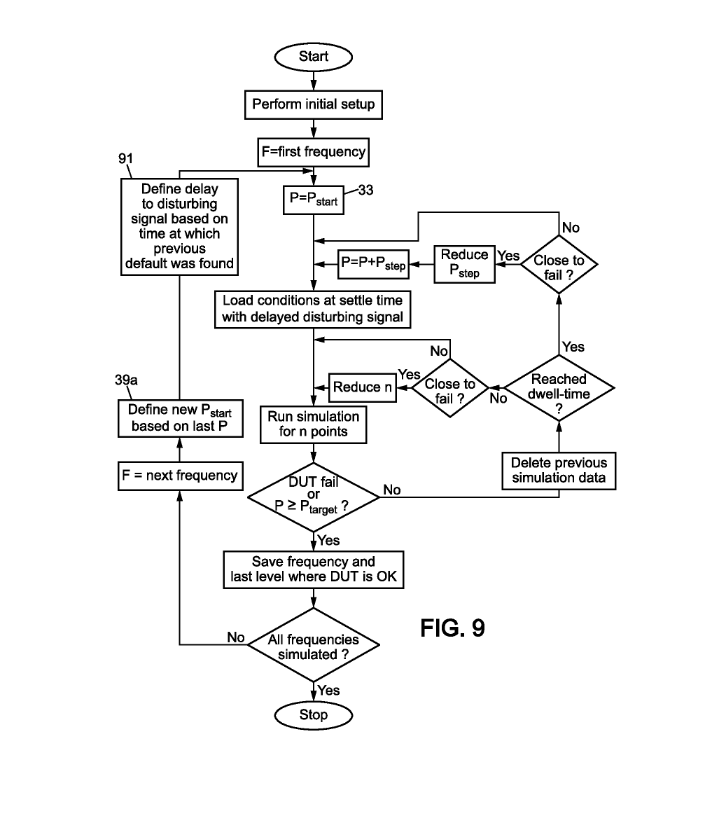

Finally, FIG. 9 illustrates a last embodiment wherein, when a default is detected, a delay of the disturbing signal for subsequent simulations at the next frequency is adjusted depending on the simulation instant at which the default has been detected within the dwell time.

This provides the advantage of advancing the time at which the default occurs in the following simulation at the next frequency, therefore reducing the simulation runtime still further. Indeed, a default is generally created by a certain combination of the disturbing signal, disturbed signal (i.e., corresponding to some critical states) and in some cases internal conditions of the device. By applying a delay to the disturbing signal it is possible to generate earlier in the simulation the default on the device.

As shown in FIG. 9, this advantage can be achieved by providing a step 91, between step 39a and step 33 of FIG. 3, comprising defining a delay applied to the disturbing signal based on the time at which, such being the case, a default was detected ate the previous frequency. For instance an algorithm executed at step 91 can change automatically the value of the delay according to the frequencies of the disturbing signal and disturbed signal.

In most embodiments there will be the possibility of enabling and disabling the various refinements described above and included in the claims below, depending on the particular case to be simulated. This can be done by the user through the graphical user interface 19 of FIG. 1.

This process can be completely automated, avoiding a tedious manual post-processing. However, the user may be offered the possibility of performing some steps manually. For instance, at step 35, the user may wish to compare the disturbed signal with the test limits manually rather than with an automated tool.

The above described automated simulation method allows optimizing the simulation runtime and the iteration number.

For instance, let us consider the simulation of an electronic device with a power step of 3 dB, with 10 simulations per frequency, and 30 frequencies. Without implementing embodiments of the invention, 300 simulations are needed, so that the simulation time vary from a few minutes at 1 MHz to several hours at 1 GHz. By using the invention, the number of iterations may be reduced to only 2 to 4 simulations per frequency, by using the maximum level at which a default was determined at the previous frequency. The number of iterations may thus be reduced to as low as 100 simulations. In addition, the simulation time may be considerably reduced at higher frequencies by delaying the disturbance to reach the default earlier.

Embodiments of the methods as broadly described above may implement soft or code representations of physical circuitry of the electronic device or of logical representations convertible into physical circuitry, such as in a hardware description language of any appropriate type.

This idea can be used for all SPICE™ immunity simulations during the design. It can be integrated in Descover™ and Mica™ simulators developed by Freescale.

Another aspect of the invention relates to a programmable apparatus comprising a simulator module configured to execute steps of a of a method as described above.

Still another aspect of the invention further relates to a computer program product comprising one or more stored sequences of instructions that are accessible to a programmable apparatus, and which, when run on the programmable apparatus cause the programmable apparatus to perform the steps of a method as described above.

The invention may thus be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM;

ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader scope of the invention as set forth in the appended claims.

Those skilled in the art will recognize that the boundaries between logic blocks represented in FIG. 1 are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, the storage units may be internal or external to the device.

Furthermore, those skilled in the art will recognize that boundaries between the above described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

1. A method of simulating Electromagnetic, EM, immunity of an electronic device, comprising:
applying a disturbing signal on at least one first entry point of a model of the device and monitoring a disturbed signal on at least one observation point of said model of the device;
automatically varying the frequency and the level of the disturbing signal stepwise until a default is just detected in the disturbed signal, wherein at each frequency and level step, a simulation is run up to a dwell time and resulting simulation data is examined for a default condition.

2. The method of claim 1 wherein simulations are run at each frequency for respective levels of the disturbing signal, either increasing up to a given maximum level or decreasing down to a given minimum level, and, when a default is just detected, said simulations at said frequency are stopped and the corresponding level is stored, and new simulations are started at a next frequency with a level reduced or increased, respectively, by a first given quantity from the stored level.

3. The method of claim 2, wherein the simulations at a given frequency are stopped when the level reaches the maximum level or minimum level, respectively, without a default being detected, and new simulations are started at the next frequency with a level reduced by a second given quantity from the maximum specified level or increased by said second defined quantity from the minimum specified level, respectively.

4. The method of claim 1 wherein, before applying the disturbing signal, a first simulation is run with no disturbing signal until a given time at which it is considered that a steady state of the device has been reached, and then data of the undisturbed signal at the observation point of the device over the dwell time are stored for use for the following simulations.

5. The method of claim 4 wherein the data of the undisturbed signal at the observation point of the device are used to generate limits around the undisturbed signal, said limits corresponding to given deviations in level and time from the undisturbed signal and being stored to be used for the following simulations.

6. The method of claim 5 wherein, at each frequency and level step, the simulation is run and resulting data of the disturbed signal at a given number of simulation instants over the dwell time is compared with the limits at corresponding instants and a default condition is considered to be met if, for at least one instant, said data exceeds said limits.

7. The method of claim 6 wherein, at each frequency and level step, the number of simulation instants at which data of the disturbed signal is compared with the limits is adjusted depending on the nearness of the disturbed signal to the limits.

8. The method of claim 5 wherein the quantity of change of level from one simulation to the other is adjusted depending on the nearness of the disturbed signal to the limits.

9. The method of claim 6 wherein, when a default is detected, a delay of the disturbing signal for subsequent simulations at a next frequency is adjusted depending on the simulation instant at which the default has been detected within the dwell time.

10. (canceled)

11. Apparatus for simulating Electromagnetic, EM, immunity of an electronic device, comprising:
a simulator module configured to apply a disturbing signal on at least one first entry point of a model of the device and monitor a disturbed signal on at least one observation point of said model of the device automatically vary the frequency and the level of the disturbing signal stepwise until a default is just detected in the disturbed signal, wherein at each frequency and level step, a simulation is run up to a dwell time and resulting simulation data is examined for a default condition.

12. The apparatus of claim 11 wherein the simulator module is further configured so that simulations are run at each frequency for respective levels of the disturbing signal, either increasing up to a given maximum level or decreasing down to a given minimum level, and so that, when a default is just detected, said simulations at said frequency are stopped and the corresponding level is stored, and new simulations are started at a next frequency with a level reduced or increased, respectively, by a first given quantity from the stored level.

13. The apparatus of claim 12, wherein the simulator module is further configured so that the simulations at a given frequency are stopped when the level reaches the maximum level or minimum level, respectively, without a default being detected, and so that new simulations are started at the next frequency with a level reduced by a second given quantity from the maximum specified level or increased by said second defined quantity from the minimum specified level, respectively.

14. The apparatus of claim 11 wherein the simulator module is further configured so that, before applying the disturbing signal, a first simulation is run with no disturbing signal until a given time at which it is considered that a steady state of the device has been reached, and then data of the undisturbed signal at the observation point of the device over the dwell time are stored for use for the following simulations.

15. The apparatus of claim 14 wherein the simulator module is further configured so that the data of the undisturbed signal at the observation point of the device are used to generate limits around the undisturbed signal, said limits corresponding to given deviations in level and time from the undisturbed signal and being stored to be used for the following simulations.

16. The apparatus of claim 15 wherein the simulator module is further configured so that, at each frequency and level step, the simulation is run and resulting data of the disturbed signal at a given number of simulation instants over the dwell time is compared with the limits at corresponding instants and a default condition is considered to be met if, for at least one instant, said data exceeds said limits.

17. The apparatus of claim 16 wherein the simulator module is further configured so that, at each frequency and level step, the number of simulation instants at which data of the disturbed signal is compared with the limits is adjusted depending on the nearness of the disturbed signal to the limits.

18. The apparatus of claim 15 wherein the simulator module is further configured so that the quantity of change of level from one simulation to the other is adjusted depending on the nearness of the disturbed signal to the limits.

19. The apparatus of claim 16 wherein the simulator module is further configured so that, when a default is detected, a delay of the disturbing signal for subsequent simulations at a next frequency is adjusted depending on the simulation instant at which the default has been detected within the dwell time.

20. The method of claim 2 wherein, before applying the disturbing signal, a first simulation is run with no disturbing signal until a given time at which it is considered that a steady state of the device has been reached, and then data of the undisturbed signal at the observation point of the device over the dwell time are stored for use for the following simulations.

21. The apparatus of claim 12 wherein the simulator module is further configured so that, before applying the disturbing signal, a first simulation is run with no disturbing signal until a given time at which it is considered that a steady state of the device has been reached, and then data of the undisturbed signal at the observation point of the device over the dwell time are stored for use for the following simulations.
